(19) United States
(12) Patent Application Publication
(10) Pub. No.: US 2026/0070423 A1
(43) Pub. Date: Mar. 12, 2026

(54) FAULT MITIGATION SYSTEM FOR ELECTRIC VEHICLES

(71) Applicant: GM Global Technology Operations LLC, Detroit, MI (US)

(72) Inventors: Shuqing Zeng, Sterling Heights, MI (US); Wei Tong, Troy, MI (US); Yao Hu, Sterling Heights, MI (US); Meng Jiang, Rochester Hills, MI (US); Hasnain Hafiz, Troy, MI (US)

(73) Assignee: GM Global Technology Operations LLC, Detroit, MI (US)

(21) Appl. No.: 18/826,290

(22) Filed: Sep. 6, 2024

(51) Int. Cl. B60L 3/00; B60L 3/04; G01C 21/34; G07C 5/08

(52) U.S. Cl. CPC B60L 3/0046; B60L 3/0069; B60L 3/04; G01C 21/3469; G01C 21/3476; G07C 5/0816; B60L 2250/16

(57) ABSTRACT

A computer-implemented method when executed by data processing hardware causes the data processing hardware to perform operations. The operations include receiving, at a monitoring application, battery data of a battery of a vehicle, detecting, via the monitoring application, a battery event based on the received battery data, and estimating, via a fault mitigation algorithm, a severity level of the battery event, the severity level being one of a first level and a second level. The operations also include executing, via the fault mitigation algorithm, mitigation actions based on the estimated severity level and communicating, via a communication system, a fault status and a mitigation plan based on the executed mitigation actions.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a fault mitigation system for electric vehicles.

Electric vehicles (EVs) are equipped with batteries that are coupled with a control system of the EV. The control system is configured to monitor the various states of the battery including a state of charge, battery temperature, and potential errors of the battery. In some instances, the control system may detect a thermal runaway event as a result of a fault to the battery. A thermal runaway event is an instance where the battery enters a self-heating state, such that an accelerated battery temperature releases energy that continuously increases the temperature of the battery. There may be varying levels of a thermal runaway event. For example, the battery may exhibit signs of a thermal runaway event prior to entering the thermal runaway event. It would be advantageous to alert occupants of the potential thermal runaway event.

Further, many vehicles utilize various navigation and telecommunication systems to route the vehicle during operation. Such systems may track the location of a vehicle and provide feedback to a driver as to the surroundings of the vehicle. Vehicles are also often equipped with a user interface that communicates information about the vehicle to the driver or other occupants. For example, the user interface may notify the driver of tire pressure changes or recommend an oil change. While conventional vehicle systems provide information to the driver, conventional systems do not typically execute actions in response to thermal runaway notifications.

Other conventional systems provide communication capabilities between a telecommunication system and an outside provider. For example, a driver may use the telecommunication system to contact the outside provider to request service to the vehicle in response to the service notification. In the event of an immediate service need, the driver may route the vehicle off a main road to contact a service provider for assistance. The conventional telecommunication system is typically operable in response to an input from the driver or occupant but rarely operates independent of driver intervention.

### SUMMARY

In some aspects, a computer-implemented method when executed by data processing hardware causes the data processing hardware to perform operations. The operations include receiving, at a monitoring application, battery data of a battery of a vehicle, detecting, via the monitoring application, a battery event based on the received battery data, and estimating, via a fault mitigation algorithm, a severity level of the battery event, the severity level being one of a first level and a second level. The operations also include executing, via the fault mitigation algorithm, mitigation actions based on the estimated severity level and communicating, via a communication system, a fault status and a mitigation plan based on the executed mitigation actions.

In some examples, the severity level may be the first level and executing the mitigation actions may include consolidating, in response to the first level of the severity level, an energy consumption of driving tasks with an energy load of the mitigation actions. In some instances, executing the mitigation plan may include estimating an available mileage based on the consolidated energy consumption. Optionally, executing the mitigation plan may include generating, based on the available mileage, a new navigation route. The operations may also include identifying, via a navigation application, a service center location, identifying, via the navigation application, a remaining route distance based on a vehicle location and a destination location, and comparing the estimated available mileage with a service distance to the service center location and the remaining route distance.

In some instances, the mitigation actions may include at least one of activating a chiller and discharging the battery. Optionally, communicating the fault status may include issuing an alert at an infotainment system of the vehicle. In other instances, estimating the severity level may include determining the severity level is the second level. In further examples, executing the mitigation actions may include reducing a speed of the vehicle and communicating the fault status and mitigation actions may include issuing an alert to stop the vehicle and exit the vehicle.

In other aspects, a fault mitigation system for a vehicle includes data processing hardware and memory hardware in communication with the data processing hardware. The memory hardware stores instructions that when executed on the data processing hardware cause the data processing hardware to perform operations. The operations include receiving, at a monitoring application, battery data of a battery of the vehicle, detecting, via the monitoring application, a battery event based on the received battery data, and estimating, via a fault mitigation algorithm, a severity level of the battery event, the severity level being one of a first level and a second level. The operations also include executing, via the fault mitigation algorithm, mitigation actions based on the estimated severity level and communicating, via a communication system, a fault status and a mitigation plan based on the executed mitigation actions.

In some examples, the severity level may be the first level and executing the mitigation actions may include consolidating, in response to the first level of the severity level, an energy consumption of driving tasks with an energy load of the mitigation actions. Optionally, executing the mitigation plan includes estimating an available mileage based on the consolidated energy consumption. In other instances, executing the mitigation plan may include generating, based on the available mileage, a new navigation route. The operations may include identifying, via a navigation application, a service center location, identifying, via the navigation application, a remaining route distance based on a vehicle location and a destination location, and comparing the estimated available mileage with a service distance to the service center location and the remaining route distance. In some instances, the mitigation actions may include at least one of activating a chiller and discharging the battery. Optionally, communicating the fault status may include issuing an alert at an infotainment system of the vehicle. In further examples, estimating the severity level may include determining the severity level is the second level. In further instances, executing the mitigation actions may include reducing a speed of the vehicle and communicating the fault status and mitigation actions may include issuing an alert to stop the vehicle and exit the vehicle.

In further aspects, a fault mitigation system for a vehicle includes data processing hardware and memory hardware in communication with the data processing hardware. The memory hardware stores instructions that when executed on the data processing hardware cause the data processing hardware to perform operations. The operations include receiving, at a monitoring application, battery data of a battery of the vehicle, detecting, via the monitoring application, a battery event based on the received battery data, and estimating, via a fault mitigation algorithm, a severity level of the battery event, the severity level being one of a first level and a second level. The operations also include executing, via the fault mitigation algorithm, mitigation actions based on the estimated severity level, estimating an available mileage based on the consolidated energy consumption, and identifying, via a navigation application, a service center location. The operations further include identifying, via the navigation application, a route distance based on a vehicle location and a destination location, comparing the route distance with a service distance to the service center location and the estimated available mileage, generating, based on the available mileage, a new navigation route, and communicating, via a communication system, a fault status and a mitigation plan based on the executed mitigation actions.

In some examples, estimating the severity level may include determining the severity level is the second level, executing the mitigation actions may include reducing a speed of the vehicle, and communicating the fault status and mitigation actions may include issuing an alert to stop the vehicle and exit the vehicle.

### BRIEF DESCRIPTION OF THE DRAWINGS

The drawings described herein are for illustrative purposes only of selected configurations and are not intended to limit the scope of the present disclosure.

FIG. 1 is a schematic of a vehicle equipped with a fault mitigation system according to the present disclosure;

FIG. 2 is an exemplary block diagram of a fault mitigation system according to the present disclosure;

FIG. 3 is another exemplary block diagram of a fault mitigation system according to the present disclosure;

FIG. 4 is an exemplary flow diagram of a fault mitigation system according to the present disclosure; and

FIG. 5 is another exemplary flow diagram of a fault mitigation system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

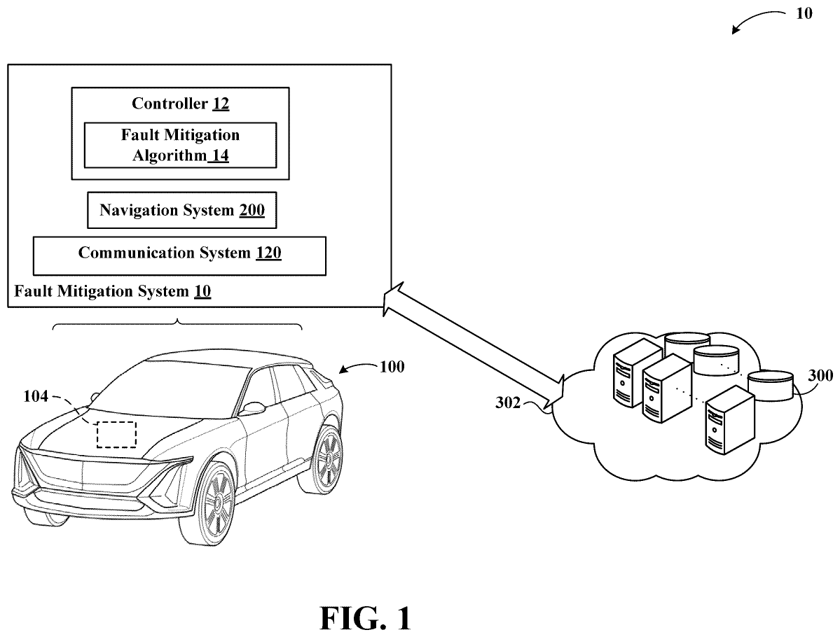

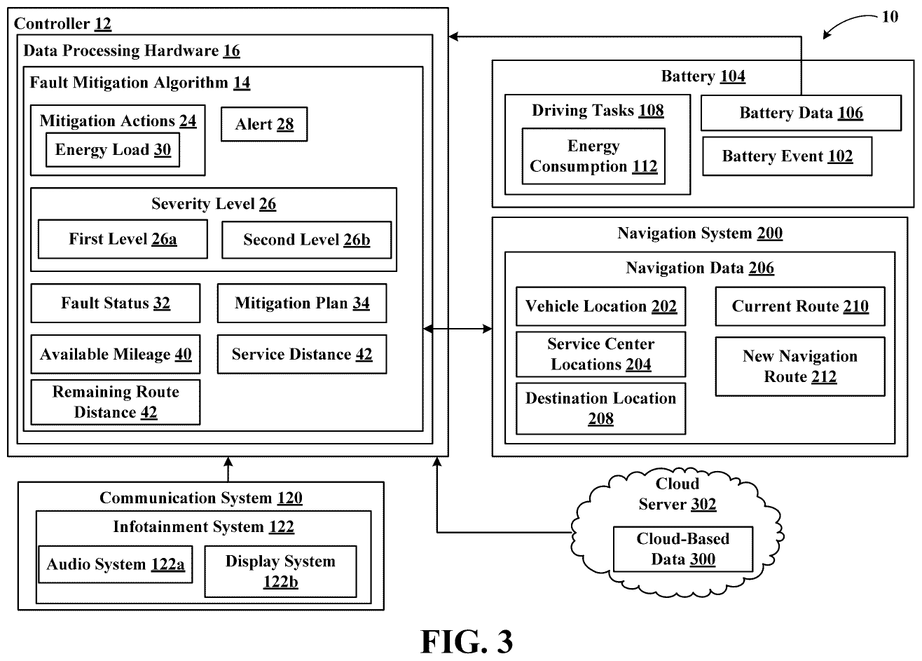

Referring to FIGS. 1-3, a fault mitigation system 10 for a vehicle 100 includes a controller 12 that is configured to execute a fault mitigation algorithm 14 in response to a battery event 102 of a battery 104 of the vehicle 100. For example, the vehicle 100 may be an electric vehicle (EV) 100 and/or a hybrid vehicle 100 that utilizes a battery 104 during operation of the vehicle 100. The controller 12 receives battery data 106 from the battery 104 and, in response to the battery event 102, the controller 12 is configured to execute the fault mitigation algorithm 14. The controller 12 includes data processing hardware 16 and memory hardware 18 in communication with the data processing hardware 16. The memory hardware 18 stores instructions that, when executed on the data processing hardware 16, cause the data processing hardware 16 to perform operations, described herein.

The controller 12 also includes a monitoring application 20 that is configured to monitor the battery data 106 for a potential battery event 102. For example, the battery event 102 may include, but is not limited to, a thermal runaway event in which the battery 104 enters a self-heating state. The battery data 106 may include, but is not limited to, a state of charge 106a, a temperature 106b, and a task load 106c. The task load 106c may be associated with various driving tasks 108 of the vehicle 100 that may utilize the battery 104 as an energy source. The monitoring application 20 is configured to monitor the battery data 106 and detect, based on the battery data 106, the battery event 102. If a battery event 102 is detected, the monitoring application 20 may issue a notification 22 to the fault mitigation algorithm 14.

The data processing hardware 14 is configured to execute the fault mitigation algorithm 14 in response to the notification 22. The notification 22 generally includes information associated with the battery event 102, including the battery data 106. The fault mitigation algorithm 14 is configured to execute mitigation actions 24 in response to the notification 22. The mitigation actions 24 may include, but are not limited to, activating a chiller 110 of the vehicle 100, discharging the battery 104, and altering the driving tasks 108 of the vehicle 100. For example, a speed 108a of the vehicle 100 may be reduced as part of the mitigation actions 24. The fault mitigation algorithm 14 determines which mitigation actions 24 to execute based on an estimated severity level 26 of the battery event 102.

The severity level 26 includes a first level 26a and a second level 26b. The first level 26a may be associated with a lower level of severity as compared with the second level 26b. For example, a battery event 102 categorized as a first level 26a may correspond to an early-stage thermal runaway battery event 102. An early-stage thermal runaway battery event 102 may occur when the battery 104 is not in a thermal runaway state, but the battery data 106 is exhibiting signs that a thermal runaway battery event 102 may occur without intervention. Thus, the first level 26a may correspond to a precursor to a thermal runaway battery event 102 in that the first level 26a is less severe than the second level 26b. The second level 26b generally corresponds to an active or imminent thermal runaway battery event 102. In some instances, the second level 22b may have a sub-range of severity that may be collectively categorized in the second level 22b. For example, the fault mitigation algorithm 14 is configured to execute mitigation actions 24, such as stopping movement of the vehicle 100, and to issue an alert 28 notifying occupants to exit the vehicle 100, described in more detail below.

As mentioned above, the monitoring application 20 of the fault mitigation system 10 may detect the battery event 102 based on the received battery data 106, and the fault mitigation algorithm 14 estimates the corresponding severity level 26 of the battery event 102. Based on the severity level 26, the fault mitigation algorithm 14 may consolidate an energy consumption 112 of the driving tasks 108 with an energy load 30 of the mitigation actions 24. For example, the energy consumption 112 may be determined based on the task load 106c of the battery data 106, as the task load 106c corresponds to the energy consumption 112 of a respective driving task 108. The consolidation of the energy consumption 112 of the driving tasks 108 with the energy load 30 of the mitigation actions 24 is utilized by the fault mitigation algorithm 14 in determining an available mileage 40 of the battery 104. The mitigation actions 24 may be adjusted based on the estimated available mileage 40 to extend the operational life of the battery 104 during the battery event 102 (i.e., activating the chiller 110 and/or reducing a speed 108a of the vehicle).

If the severity level 26 is determined to be the second level 26b, the fault mitigation algorithm 14 may execute a mitigation action 24 to reduce the speed 108a of the vehicle 100 to a stop, after communicating a fault status 32 and a mitigation plan 34 with the occupant(s). For example, the mitigation plan 34 may include issuing an alert 28 to stop the vehicle 100 and exit the vehicle 100 in the event of the second level 26b of the battery event 102. The vehicle 100 may be configured to autonomously slow the vehicle 100 to a stop or may be manually operated by the occupant to maneuver the vehicle 100 to a safe location before stopping and exiting the vehicle 100. In some examples, the available mileage 40 may be utilized to identify a distance range that the occupant may utilize to identify a safe place to maneuver the vehicle 100 before stopping and exiting the vehicle 100.

Referring still to FIGS. 1-3, the fault mitigation system 10 also includes a navigation system 200 configured to monitor a vehicle location 202 and identify service center locations 204. The navigation system 200 communicates navigation data 206 with the controller 12 for use with the fault mitigation algorithm 14. For example, the fault mitigation algorithm 14 may utilize the navigation data 206 to generate the mitigation plan 34 by assessing the available mileage 40 in comparison with the vehicle location 202, the service center locations 204, and a destination location 208. Each of the vehicle location 202, the service center locations 204, and the destination location 208 may be communicated as the navigation data 206 to the fault mitigation algorithm 14. For example, the fault mitigation algorithm 14 may identify the service center locations 204 by communicating with the navigation system 200.

The fault mitigation algorithm 14 is configured to evaluate the available mileage 40 in comparison with the estimated driving distance, which includes a remaining route distance 42 in a current route 210 of the vehicle 100 and a service distance 44 to the nearest service center location 204. For example, the fault mitigation algorithm 14 may identify the remaining route distance 42 based on the vehicle location 202 and the destination location 208. The available mileage 40 is estimated based on the consolidated energy consumption 112. In some instances, the fault mitigation algorithm 14 estimates the available mileage 40 based on the consolidated energy consumption 112 as part of executing the mitigation actions 24. The available mileage 40 is compared with the combination of the remaining route distance 42 and the service distance 44. If the available mileage 40 exceeds the combination of the remaining route distance 42 and the service distance 44, then the fault mitigation algorithm 14 may determine that the vehicle 100 may continue on the current route 210.

In some instances, the available mileage 40 may be less than the combination of the remaining route distance 42 and the service distance 44. As a result, the fault mitigation algorithm 14, as part of the mitigation actions 24 and/or mitigation plan 34, may estimate and execute a new navigation route 212 based on the available mileage 40. The navigation data 206 may also include cloud-sourced data 300 from a cloud server 302, such as traffic patterns, weather, and road conditions that may also be utilized by the fault mitigation algorithm 14 in estimating the new navigation route 212. The fault mitigation algorithm 14 is configured to continuously receive the cloud-sourced data 300 from the cloud server 302 to continuously improve the estimation of the available mileage 40.

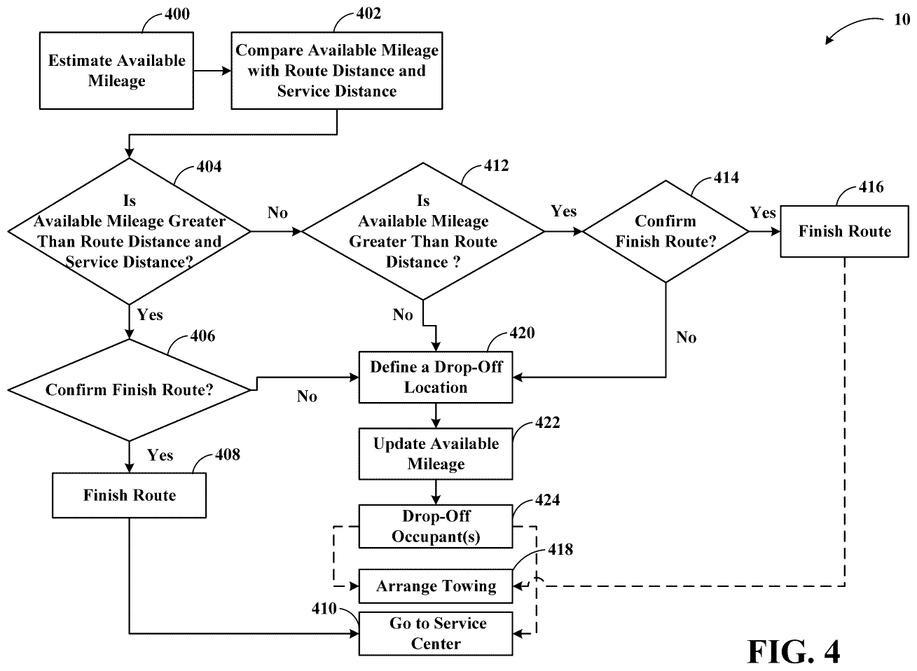

FIG. 4 illustrates an exemplary flow diagram of the fault mitigation system 10 executing navigation functions. At 400, the fault mitigation algorithm 14 estimates the available mileage 40. The fault mitigation algorithm 14, at 402, compares the available mileage 40 with the remaining route distance 42 and the service distance 44 to the service center location 204. At 404, the fault mitigation algorithm 14 determines whether the available mileage 40 is greater than the remaining route distance 42 and the service distance 44 to service center location 204. If the available mileage 40 is greater than the combined remaining route distance 42 and the service distance 44, then the fault mitigation algorithm 14 prompts, at 406, the occupant to confirm whether to finish the route 210. If the occupant confirms, then the vehicle 100 may finish the route 210, at 408, and then proceed, at 410, to the service center location 204. For example, the vehicle 100 may be an autonomous vehicle 100 that may drop-off the occupant at the destination location 208 and proceed to the service center location 204.

If the available mileage 40 is less than the combined route distance 42 and the service distance 44, then the fault mitigation algorithm 14, at 412, determines whether the available mileage 40 is greater than the route distance 42. If the available mileage 40 is greater than the route distance 42, then the fault mitigation algorithm 14 prompts, at 414, the occupant to confirm whether to finish the route 210. If the occupant confirms, then the vehicle 100 may finish the route 210, at 416. Upon completion of the route 210, the fault mitigation system 10 may arrange, at 418, towing for the vehicle 100 from the destination location 208.

If the available mileage 40 is less than the route distance 42 or if the occupant does not confirm finishing the route 210, the fault mitigation system 10, at 420, defines a drop-off location 214 and updates, at 422, the available mileage 40. For example, the fault mitigation algorithm 14 may subtract the mileage to arrive at the drop-off location 214 to determine the updated available mileage 40. The occupant, at 422 is dropped off, and the fault mitigation system 10 may proceed with arranging, at 418, towing of the vehicle 100 or may proceed, at 410, to the service center location 204, depending on the available mileage 40.

Referring again to FIGS. 1-3, the fault mitigation system 10 also includes a communication system 120 of the vehicle 100. The fault mitigation system 10 utilizes the communication system 120 to communicate each of the mitigation actions 24, the fault status 32, and/or the mitigation plan 34 with occupants of the vehicle 100. For example, the communication system 120 may include an infotainment system 122 that includes an audio system 122a and display 122b of the vehicle 100. The fault mitigation algorithm 14 may audibly announce the fault status 32 over the audio system 122a and may display the mitigation actions 24 on the display 122b. The fault status 32 may be communicated via a light, an audio notification, a tactile notification, or any other practicable notification method to communicate the fault status 32 with the occupant(s). For example, the fault status 32 may be communicated with the occupant(s) by the fault mitigation algorithm 14 issuing the alert 28 at the infotainment system 122.

As mentioned above, the fault mitigation system 10 may present at the infotainment system 122 prompts for the occupant based on the mitigation actions 24 and/or the mitigation plan 34. The occupant may be informed of the mitigation actions 24 executed by the fault mitigation system 10 and may provide input as to the mitigation plan 34. For example, the occupant may indicate whether to proceed with finishing the current route 210 when prompted by the fault mitigation algorithm 14. Thus, the fault mitigation system 10 keeps the occupant informed with respect to the battery event 102 through alerts 28 and the fault status 32. In some instances, the fault mitigation system 10 may utilize the cloud servers 302 to communicate with a user device of the occupant, such that the alerts 28 may be communicated via phone and text messages.

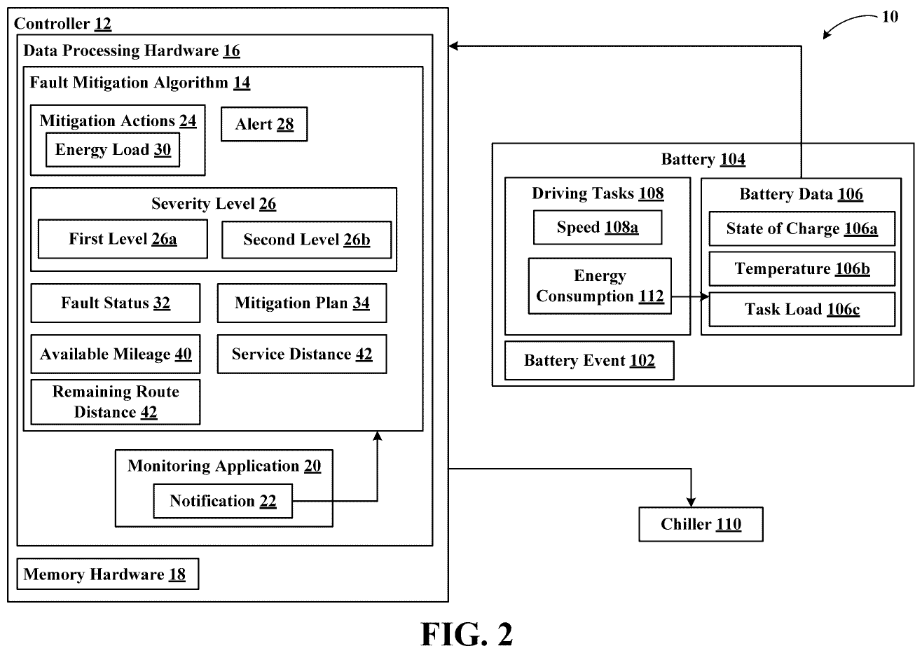

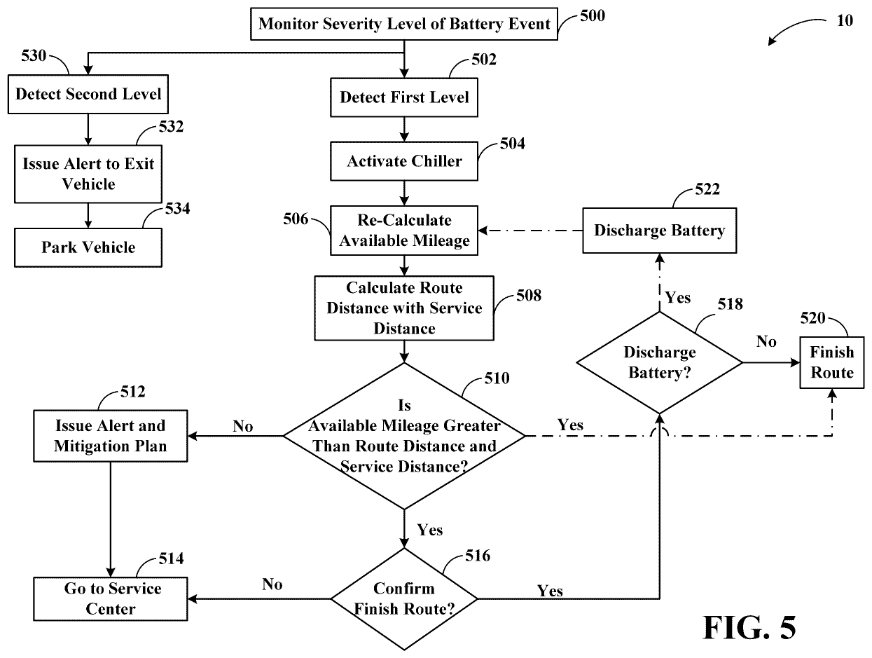

With reference to FIGS. 2-5, an exemplary flow diagram of the fault mitigation system 10 is illustrated at FIG. 5. The fault mitigation system 10, at 500, monitors a severity level 26 of a battery event 102. The fault mitigation algorithm 14 may detect, at 502, a first level 26a of the severity level 26 and may activate, at 504, the chiller 110. In other examples, the fault mitigation algorithm 14 may activate or execute, at 504, other mitigation actions 24, described above. The fault mitigation algorithm 14 re-calculates, at 506, the available mileage 40 of the battery 104 and calculates, at 508, the route distance 42 in combination with the service distance 44. At 510, the fault mitigation algorithm 14 determines whether the available mileage 40 is greater than the remaining route distance 42 and the service distance 44. If the available mileage 40 is less than the combined remaining route distance 42 and the service distance 44, then the fault mitigation algorithm 14 issues, at 512, an alert 28 and the mitigation plan 34. The fault mitigation system 10 may then, at 514, proceed to the service center location 204.

If the available mileage 40 is greater than the route distance 42 and the service distance 44, then the fault mitigation system 10 may prompt, at 516, the occupant to confirm whether to finish the current route 210. If the occupant rejects the prompt to continue, the fault mitigation system 10 may proceed, at 514, to the service center location 204. If the occupant confirms to continue on the current route 210, the fault mitigation system 10 determines, at 518, whether to discharge the battery 104. If the fault mitigation system 10 determines not to discharge the battery 104, then the fault mitigation system 10 may, at 520, finish the route 210.

If the fault mitigation system 10 determines to discharge the battery 104, the fault mitigation system 10 discharges, at 522, the battery 104 and proceeds to recalculate, at 506, the available mileage 40. The decision path of the fault mitigation system 10 after discharging the battery 104 is illustrated in dashed lines to depict the optional nature of the path. The fault mitigation system 10 proceeds with steps 506-510, as set forth above. Once arriving at decision step 510, after discharging the battery 104, the fault mitigation system 10 may optionally proceed with finishing the route 210, at 520, if the available mileage 40 is greater than the combined route distance 42 and the service distance 44. Otherwise, the fault mitigation system 10 proceeds to issue, at 512, the alert 28 and mitigation plan 34 prior to proceeding, at 514, to the service center location 204.

In other examples, the fault mitigation system 10 may detect, at 530, a second level 26b of the severity level 26 of the battery event 102. In response, the fault mitigation system 10 may issue, at 532, an alert 28 to occupants to exit vehicle 100. At 534, the fault mitigation system 10 may place the vehicle 100 in park, and the occupants may safely exit the vehicle 100. The steps set forth in FIG. 5 are exemplary and may be combined with the steps set forth in FIG. 4, where the fault mitigation system 10 assesses and generates a new navigation route 212. The steps 400-424, 500-534 may be executed in a combination of orders consistent with the general order set forth throughout the disclosure. Thus, the fault mitigation system 10 is not limited to the order of operations set forth in both exemplary flow diagram of FIGS. 4 and 5.

Referring again to FIGS. 1-5, the fault mitigation system 10 advantageously identifies a battery event 102 and implements a mitigation plan 34 in response to the battery event 102. For example, the fault mitigation algorithm 14 estimates the available mileage 40 and executes various mitigation actions 24 described above based on the available mileage 40. Further, the fault mitigation system 10 utilizes the navigation system 200 to generate a new navigation route 212 based on the available mileage 40 and service center locations 204. The new navigation route 212 may be presented to the user on the infotainment system 122 and/or through an alert 28 on a user device of the occupant. Thus, the occupant is notified and informed of the battery event 102 and assured that the fault mitigation system 10 has identified and determined a mitigation plan 34 based on the fault status 32 and including mitigation actions 24. The fault mitigation system 10 advantageously provides automatic adjustment to the current route 210 and takes action to mitigate the battery event 102 while keeping the occupant informed.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
receiving, at a monitoring application, battery data of a battery of a vehicle;
detecting, via the monitoring application, a battery event based on the received battery data;
estimating, via a fault mitigation algorithm, a severity level of the battery event, the severity level being one of a first level and a second level;
executing, via the fault mitigation algorithm, mitigation actions based on the estimated severity level; and
communicating, via a communication system, a fault status and a mitigation plan based on the executed mitigation actions.

2. The method of claim 1, wherein the severity level is the first level and executing the mitigation actions includes consolidating, in response to the first level of the severity level, an energy consumption of driving tasks with an energy load of the mitigation actions.

3. The method of claim 2, wherein executing the mitigation plan includes estimating an available mileage based on the consolidated energy consumption.

4. The method of claim 3, wherein executing the mitigation plan includes generating, based on the available mileage, a new navigation route.

5. The method of claim 3, further including:
identifying, via a navigation application, a service center location;
identifying, via the navigation application, a remaining route distance based on a vehicle location and a destination location; and
comparing the estimated available mileage with a service distance to the service center location and the remaining route distance.

6. The method of claim 1, wherein the mitigation actions include at least one of activating a chiller and discharging the battery.

7. The method of claim 1, wherein communicating the fault status includes issuing an alert at an infotainment system of the vehicle.

8. The method of claim 1, wherein estimating the severity level includes determining the severity level is the second level.

9. The method of claim 8, wherein executing the mitigation actions includes reducing a speed of the vehicle and communicating the fault status and mitigation actions includes issuing an alert to stop the vehicle and exit the vehicle.

10. A fault mitigation system for a vehicle, the fault mitigation system comprising:
data processing hardware; and
memory hardware in communication with the data processing hardware, the memory hardware storing instructions that when executed on the data processing hardware cause the data processing hardware to perform operations comprising:
receiving, at a monitoring application, battery data of a battery of the vehicle;
detecting, via the monitoring application, a battery event based on the received battery data;
estimating, via a fault mitigation algorithm, a severity level of the battery event, the severity level being one of a first level and a second level;
executing, via the fault mitigation algorithm, mitigation actions based on the estimated severity level; and
communicating, via a communication system, a fault status and a mitigation plan based on the executed mitigation actions.

11. The fault mitigation system of claim 10, wherein the severity level is the first level and executing the mitigation actions includes consolidating, in response to the first level of the severity level, an energy consumption of driving tasks with an energy load of the mitigation actions.

12. The fault mitigation system of claim 11, wherein executing the mitigation plan includes estimating an available mileage based on the consolidated energy consumption.

13. The fault mitigation system of claim 12, wherein executing the mitigation plan includes generating, based on the available mileage, a new navigation route.

14. The fault mitigation system of claim 12, further including:
identifying, via a navigation application, a service center location;
identifying, via the navigation application, a remaining route distance based on a vehicle location and a destination location; and
comparing the estimated available mileage with a service distance to the service center location and the remaining route distance.

15. The fault mitigation system of claim 10, wherein the mitigation actions include at least one of activating a chiller and discharging the battery.

16. The fault mitigation system of claim 10, wherein communicating the fault status includes issuing an alert at an infotainment system of the vehicle.

17. The fault mitigation system of claim 10, wherein estimating the severity level includes determining the severity level is the second level.

18. The fault mitigation system of claim 17, wherein executing the mitigation actions includes reducing a speed of the vehicle and communicating the fault status and mitigation actions includes issuing an alert to stop the vehicle and exit the vehicle.

19. A fault mitigation system for a vehicle, the fault mitigation system comprising:
data processing hardware; and
memory hardware in communication with the data processing hardware, the memory hardware storing instructions that when executed on the data processing hardware cause the data processing hardware to perform operations comprising:
receiving, at a monitoring application, battery data of a battery of the vehicle;
detecting, via the monitoring application, a battery event based on the received battery data;
estimating, via a fault mitigation algorithm, a severity level of the battery event, the severity level being one of a first level and a second level;
executing, via the fault mitigation algorithm, mitigation actions based on the estimated severity level;
estimating an available mileage based on the consolidated energy consumption;
identifying, via a navigation application, a service center location;
identifying, via the navigation application, a route distance based on a vehicle location and a destination location;
comparing the route distance with a service distance to the service center location and the estimated available mileage;
generating, based on the available mileage, a new navigation route; and
communicating, via a communication system, a fault status and a mitigation plan based on the executed mitigation actions.

20. The fault mitigation system of claim 19, wherein estimating the severity level includes determining the severity level is the second level, executing the mitigation actions includes reducing a speed of the vehicle, and communicating the fault status and mitigation actions includes issuing an alert to stop the vehicle and exit the vehicle.
